(19) United States
(12) Patent Application Publication
(10) Pub. No.: US 2002/0108303 A1
(43) Pub. Date: Aug. 15, 2002

(54) Plant support

(76) Inventor: Charles E. Layton JR., Saluda, SC (US)

Correspondence Address: MICHAEL A. MANN, NEXSEN PRUET JACOBS & POLLARD LLC, PO DRWR 2426, COLUMBIA, SC, 29202-2426, US

(21) Appl. No.: 10/117,253

(22) Filed: Apr. 5, 2002

Related U.S. Application Data
(63) Continuation-in-part of application No. 09/735,070, filed on Dec. 12, 2000.

(51) Int. Cl. A01G 17/06; A01G 17/14

(52) U.S. Cl. 47/45

(57) ABSTRACT

A support for a branched plant includes an upper perimeter spaced apart by two or more spacers from a lower perimeter. The lower perimeter compression fits into a flower pot, resting on the ledge on the interior surface of the pot so that the upper perimeter extends above the top edge of the poet. the upper perimeter provides support for the branches of a mature branched flower, holding them in such a way as to display them without either bunching them too tightly or allowing them to spread out too much. The display is achieved by the right combination of spacing of the upper perimeter above the flower pot and diameter of the upper perimeter for a given size of plant. The support may be molded as a flat price and then formed into a cylinder when its ends are snap fitted together. When the plant is immature, the support is applied so that, by the time the plant blooms, the support is there to provide support for its stems.

### RELATED APPLICATION

This application is a continuation in part of U.S. application Ser. No. 09/735,070, filed Dec. 12, 2000.

### FIELD OF THE INVENTION

The present invention relates generally to supports for potted plants such as mums and poinsettias.

### BACKGROUND OF THE INVENTION

Certain potted plants are physically fragile. These include branched plants such as mums and poinsettias. Their blooms are full and heavy and tend to cause their supporting branches to droop and break, especially during handling. To prevent these types of plants from having branches break off, they are usually tied just below the blooms with string or yarn. The yarn tie collects the branches within a loose horizontal circle formed by the tie. The tie helps to hold the plant together and enables the collected branches to support the individual ones near the perimeter of the plant from drooping outward. Tying takes time, however, and in the competitive market of commercial flower growing, any additional cost, particularly one that requires labor, is to be avoided if possible.

In addition to yarn ties, here are a number of mechanical plant supports in the prior art. Usually these are posts that are inserted into the flower pot to provide a vertical support to which the plant can be tied. One particular support includes a ring for encircling the stems of a plant. The ring is supported by vertical members clipped to the top edge of the flower pot. Although this particular support provides adequate support while the plant is stationary, it too easily comes loose when the plant is being moved.

Thus there remains a need for a secure, effective and inexpensive way to support a branched plant as it grows to maturity.

### SUMMARY OF THE INVENTION

According to its major aspects and briefly recited, the present invention is a support for a branched plant. The support includes an upper perimeter spaced apart by two or more spacers from a lower perimeter. The lower perimeter compression fits into a flower pot so that the lower perimeter rests on the interior ledge of the flower pot and the upper perimeter extends above the top of the pot. The upper perimeter provides support for the branches of a mature branched flower, holding them in such a way as to display them without either bunching them too tightly or allowing them to spread out too much.

A feature of the present invention is the use of the flower pot in combination with the lower perimeter to support and center the upper perimeter. This feature helps to center the flower and provides support for the flower based ultimately on the weight of the plant, its roots and the soil it is planted in.

Another important feature of the present invention is the use of the interior ledge of the flower pot as a resting place for the lower perimeter of the support. The ledge on the interior of an injection molded pot makes certain that the lower perimeter, and consequently the upper perimeter, are level and therefore supports the flower firmly and evenly.

Still another important feature of the present invention is the dimensions of the upper perimeter and the spacers. These two components cooperate to display the mature branched flower to best advantage. The height of the spacers and diameter of the upper perimeter dictate whether the flower is bunched too tightly or too loosely. Within a reasonable range, and for a given size pot, there will be an preferred range of spacer heights and upper perimeter diameters.

Yet another feature of the present invention is the method for making the plant support by first forming a flat support with upper and lower perimeters and spacers lying in the same plane. Snap fasteners are formed in the ends of the upper and lower perimeters to allow the plant support to be formed to fit into a circle that may be received in pots of different sizes.

The present flower support adds support and stability to bunched flowers in flower pots and improves their appearance in the pot, adding value and reducing the cost of damaged flowers to growers.

These and other features and their advantages will be apparent to those skilled in the art of growing potted, bunched flowers from a careful reading of the Detailed Description of Preferred Embodiments, accompanied by the following drawings.

### BRIEF DESCRIPTION OF THE DRAWINGS

In the drawings,

FIG. 1 is a perspective view of a flower support in accordance with a preferred embodiment of the present invention;

FIG. 2 is a cross sectional view of a support taken along lines 2-2 of FIG. 1, according to a preferred embodiment of the present invention;

FIG. 3 is a perspective view showing the installation of a support according to a preferred embodiment of the present invention;

FIG. 4 is a top view of an alternate embodiment of the present invention prior to fastening into a cylinder, according to a preferred embodiment of the present invention; and

FIG. 5 is a detail of the view of FIG. 4 showing the fasteners.

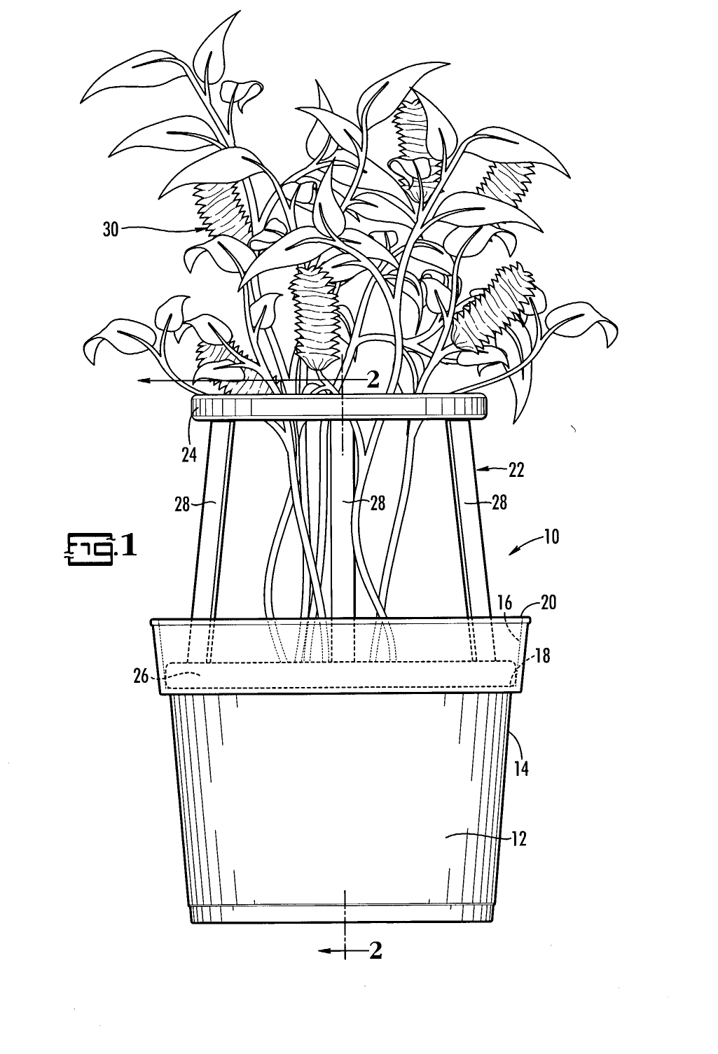

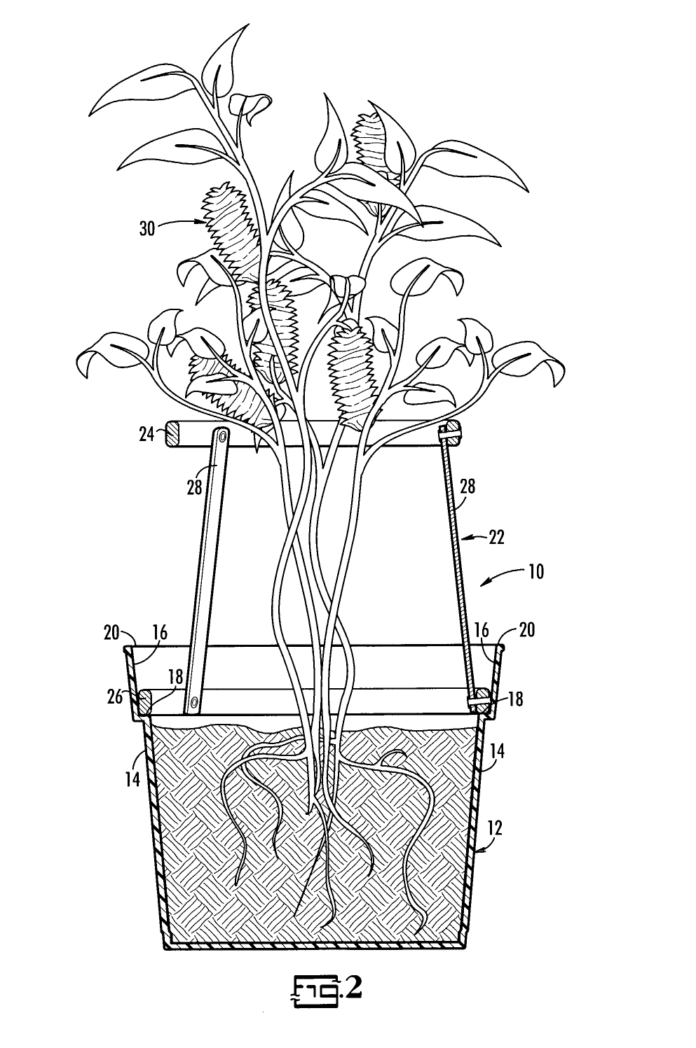

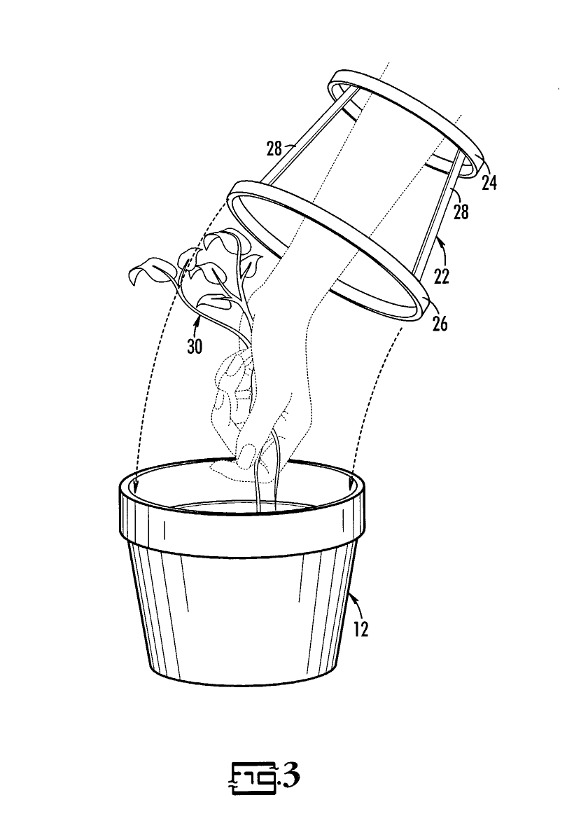

### DETAILED DESCRIPTION OF PREFERRED EMBODIMENTS

The present invention is a support for branched flowers in a standard commercial flower pot. The present invention is also the combination of a support and the standard commercial flower pot. The purpose of the support is to hold the branches of the branched flower in a natural arrangement that displays the flowers in an attractive way, where the blooms are not too close together and not too loose, and, by doing so, to prevent blooms from drooping or breaking.

Branched flowers are those that have many branches which collectively terminate in a cluster of blooms. The branched flowers grown commercially in the greatest numbers include mums and poinsettias. Because of the weight of their blooms, the branches near the periphery of the plant often break or at least droop under the bloom's weight. Those in the interior of the plant tend to support each other. In handling, many of the blooms do in fact break off. Damaged plants are worth less than undamaged plants.

These plants do not need support when they are young but as they mature, their need for support increases is proportion to their size and maximizes when they bloom. Once fully grown, that is, “mature” and ready for delivery to the markets, the plants look best when the blooms are spaced closely but not bunched and not loose or drooping. The natural geometry of the stems and size of the blooms dictate the relative spacing of the blooms. Commercial growers will be familiar with the natural spacing of the blooms of these plants.

Branched plants are grown in standard sized flower pots. These pots may be six, eight, and ten inches in diameter. Typically, these pots are made by injection molding, are frustoconical in shape and have a sharp but small change in diameter near their tops to create a flange on the exterior and a corresponding ledge on the interior. Nearly all commercial branched flowers are grown in this type of pot. The present support works in combination with this type of pot; that is, with a pot having a frustoconical shape and an interior ledge.

Referring now to the figures, there is shown a pot support system according to a preferred embodiment of the present invention and generally indicated by reference number 10. System 10 includes a flower pot 12 with a side wall 14 and an interior surface 16. A ledge 18 is formed on interior surface 16. Flower pot 12 has a top edge 20 of side wall 12.

Support 22 includes an upper perimeter 24 and a lower perimeter 26 spaced a fixed distance apart from upper perimeter 24 by at least two, and preferably three or four, spacers 28. Upper perimeter may take on any closed shape but a circular shape or overlapping “C” shape requires less material and corresponds to the shape of flower pot 12 and is therefore preferred.

Lower perimeter 26 may take on various shapes and need not necessarily be a closed shape but again, a circular or overlapping “C” shape is strongly preferred. Upper perimeter 24 is preferably closed so that, when in use, there are no gaps or openings for branches of a flower 30 to fall through. Lower perimeter 26 secures support 22 to flower pot 12 and, in combination with spacers 28, centers and holds upper perimeter 24 in a position where extends above top edge 20 of flower pot 12, and is also preferably level and at a suitable height above top edge 20, below the blooms of the mature flower 30.

Spacers 28 space and support upper perimeter 24 above top edge 20 without blocking light and air flow to the base of flower 30. Light, air and air flow are important to the health of flower 30. Light energy and the carbon dioxide in the air are required for photosynthesis by the leaves of flower 30; air flow maintains the moisture content of the air between the pot and the plant at appropriate levels so molds and fungus do not thrive. Furthermore, the less obtrusive spacers 28 are, the better will be the appearance of system 10.

Preferably support 22 is made of injection molded plastic, the same plastic and preferably the same color as flower pot 12. Most preferably, upper perimeter 24, lower perimeter 26 and spacers 28 are integrally formed; that is, they are made in one piece. When injection molded in one piece, lower perimeter 26 may be made to be larger than upper perimeter 24 so that releasing support 22 from the injection mold is easier. Alternatively, support 22 may be cylindrical, with upper perimeter 24 and lower perimeter 26 having the same circumference. The advantage of this latter embodiment is that support 22 then has no preferred orientation; it may be used right-side up or upside down.

Thus, lower perimeter 26 is preferably dimensioned to be compression fitted into flower pot 12, most preferably to rest on interior ledge 18. Upper perimeter 24 is preferably the same size in diameter or smaller in diameter than lower perimeter 26. Upper perimeter 26 is also preferably sized to display flower 30 properly when it is mature (i.e., ready to deliver to the market for sale). As stated before, the geometry of the particular bunched flower tends to dictate when the flowers of the plant are too close and too loose and those skilled in the art of commercial flower growing will be able to determine the appropriate degree of closeness of the blooms of flower 30.

The distance spacers 28 space upper perimeter 24 from lower perimeter 26 works in combination with the diameter of upper perimeter 24 to achieve the right display of flower 30. The greater the spacing provided by spacers 28 is for a given diameter of upper perimeter 24, the tighter the display. Conversely, the smaller the diameter of upper perimeter 26 for a give size of spacer 28, the tighter the display.

As a first example of the dimensions of the present invention, for a six inch flower pot, upper perimeter 24 is preferably 5 inches; lower perimeter 26 is preferably 5 inches to 5⅞ inches; spacers 28 are preferably 3¾ inches. When support 22 is made of vinyl rods having a diameter of ⅛ to 3/16 inches, four spacers 28 are preferred for stiffness and stability.

As a second example of the dimensions of a cylindrical support 22, for a six inch pot, it may have a height of approximately 3.8 inches, a thickness of 0.05 inches, a diameter of 5.5 inches, and upper and lower perimeters 24, 26, of 0.5 inches in width. A cylindrical support for a 6.5 inch pot would have a diameter of 6 inches.

Support 22 may be installed on flower pot 12 at any time before flower 30 reaches maturity but is preferably installed after flower 30 is just slightly taller than the top of upper perimeter 24. To install support 22, it is placed on the arm of the installer with lower perimeter 26 toward the fingers and upper perimeter 24 toward the elbow. The flower 30 is grasped gently in the hand of the installer and held while support 22 is slid from the arm, over the hand and flower 30, and onto flower pot 12. There, it is firmly pressed into position on ledge 18, which flower 30 extending through the middle of upper perimeter 24. Once compressed fitted into pot 12 and resting on ledge 18, support 22 will be coupled to pot 12 and, together with pot 12, the soil in the pot and the roots of flower 30, will remain securely in place, even during the handling of flower pot 12.

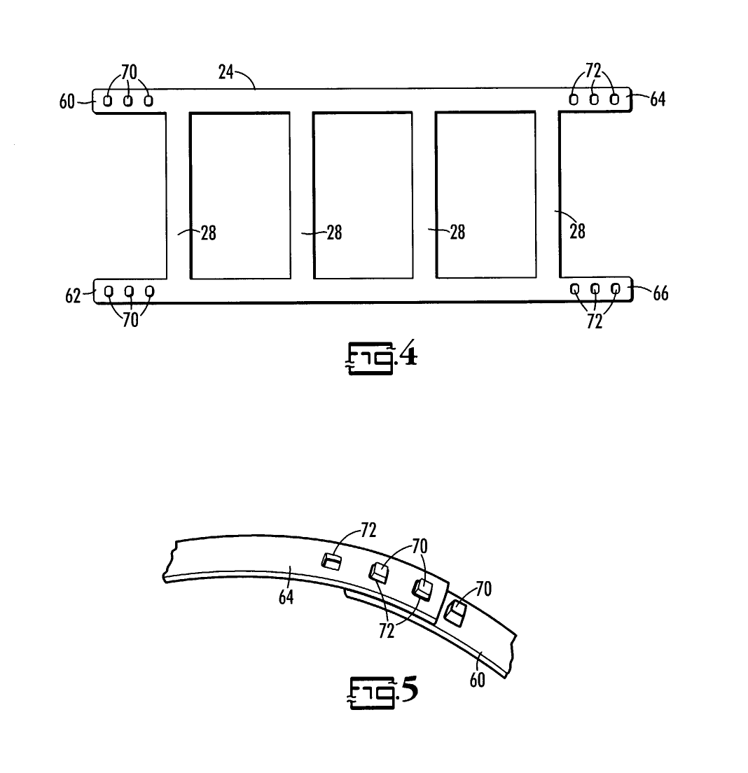

Support 22 may be made as follows. It may be molded as a flat piece of plastic roughly in the shape of a ladder as shown in FIG. 4, with upper perimeter 24 on the left and lower perimeter 26 on the right, and spacers 28 running therebetween. Formed in the ends 60, 62, 64, and 66 of upper and lower perimeters 24 and 26, are series of corresponding projections 70 and holes 72. Holes 72 are dimensioned to be the same size or just slightly smaller than projections so that projections 70 can be compression fitted into holes 72. When ends 60 and 64 of upper perimeter 24 are brought together, projection 70 from end 60 can be pressed into a hole 72 of end 64. Similarly, when ends 62 and 66 of lower perimeter 26 are brought together, a projection 70 from end 62 can be pressed into a hole 72 of end 66. Projections 70 pressed into holes 72 will hold the ends 60, 62, 64, and 66 of upper and lower perimeters 24, 26 in a cylindrical shape for use as a plant support.

Support 22 can be applied to a plant after the plant canopy is slightly above the top of support 22 or support 22 can be wrapped around a plant and snapped together whenever the plant is almost finished growing.

It will be apparent to those skilled in the art of commercial flower production that many modifications and substitutions can be made to the foregoing detailed description of preferred embodiments without departing from the spirit and scope of the present invention, defined by the appended claims.

What is claimed is:

1. A device for use in supporting a plant, said device comprising:
a flower pot having a top edge; and
a frame having
an upper perimeter having a pair of opposing ends,
a lower perimeter having a pair of opposing ends,
means for spacing said upper perimeter a fixed distance from said lower perimeter so that air and light can pass between said upper perimeter and said lower perimeter,
means formed on said pair of opposing ends of said upper perimeter for releasibly fastening said opposing ends together for forming said upper perimeter into a circle, and
means formed on said pair of opposing ends of said lower for releasibly fastening said opposing ends together for forming said lower perimeter into a circle dimensioned to fit within said top edge of said flower pot.

2. The device as recited in claim 1, wherein said flower pot has a ledge below said top edge and wherein said lower perimeter is dimensioned to rest on said ledge.

3. The device as recited in claim 1, wherein said spacing means further comprises plural spacers.

4. The device as recited in claim 1, wherein said upper perimeter fastening means is a series of projections on one end of said pair of opposing ends and a series of holes formed in another end of said pair of opposing ends, said projections being pressible into said holes.

5. The device as recited in claim 1, wherein said frame, when said upper perimeter is formed into said circle and said lower perimeter is formed into said circle, defines a cylinder.

6. A device for use in supporting a plant, said device comprising:
a flower pot having a top edge; and
a frame having
an upper perimeter having a pair of opposing ends,
a lower perimeter having a pair of opposing ends,
means for spacing said upper perimeter a fixed distance from said lower perimeter so that air and light can pass between said upper perimeter and said lower perimeter,
means formed on said pair of opposing ends of said upper perimeter for fastening said opposing ends together for forming said upper perimeter into a circle, and
means carried by said pair of opposing ends of said lower perimeter for fastening said opposing ends together for forming said lower perimeter into a circle, said lower perimeter, when said opposing ends are fastened together being dimensioned to fit within said top edge of said flower pot.

7. The device as recited in claim 6, wherein said spacing means is plural spacers.

8. The device as recited in claim 6, wherein said spacing means is four spacers.

9. The device as recited in claim 6, wherein said frame defines a cylinder.

10. The device as recited in claim 6, wherein said fastening means carried by said opposing ends of said upper perimeter includes a hole and a projection, said projection being dimensioned to just fit into said hole.

11. The device as recited in claim 10, wherein said fastening means carried by said opposing ends of said lower perimeter includes a hole and a projection, said projection dimensioned to just fit into said hole.

12. The device as recited in claim 6, wherein said fastening means carried by said opposing ends of said upper perimeter are at least two holes and a projection, said projection being dimensioned to just fit into each hole of said at least two holes.

13. The device as recited in claim 6, wherein said fastening means carried by said opposing ends of said upper perimeter are at least two projections and a hole, said hole being dimensioned to just receive a projection of said at least two projections.
